(19) United States
(12) Patent Application Publication
(10) Pub. No.: US 2007/0262508 A1
(43) Pub. Date: Nov. 15, 2007

(54) Positioning Apparatus and Positioning System Having the Same

(76) Inventor: Yosuke Haruna, Kobe-shi (JP)

Correspondence Address: BACON & THOMAS, PLLC, 625 SLATERS LANE, FOURTH FLOOR, ALEXANDRIA, VA, 22314, US

(21) Appl. No.: 11/660,596

(22) PCT Filed: Aug. 8, 2005
(86) PCT No.: PCT/JP05/14501

§ 371 Date: Feb. 20, 2007

(30) Foreign Application Priority Data
Aug. 20, 2004 (JP) 2004-270541

(51) Int. Cl. B23Q 3/00

(52) U.S. Cl. 269/309

(57) ABSTRACT

An annular plug (12) to be inserted into a cast hole (11) of a work (M) is projected upward from a housing (3). In a peripheral wall (13) of the annular plug (12), through holes (14) extending radially are formed at intervals circumferentially. A ball (15) is inserted into each of the through holes (14). An operating rod (18) is inserted into a cylindrical hole (17) of the annular plug (12). In an outer peripheral surface of an upper end portion of the operating rod (18), accommodating grooves (19) extending vertically are formed at intervals circumferentially corresponding to the balls (15). Guide surfaces (24, 24, 24) are formed between the adjacent accommodating grooves (19, 19). These guide surfaces (24) are fitted into the cylindrical hole (17) so as to be prevented from moving radially and allowed to move axially.

### TECHNICAL FIELD

The present invention relates to a positioning apparatus for positioning a movable member such as a work with respect to a reference member such as a work pallet and a positioning system having the same.

### BACKGROUND OF THE INVENTION

As such a type of apparatus, one described in Patent Document 1 (Japanese Unexamined Patent Publication No. 7-314270) is conventionally available. This prior art relates to a positioning apparatus with a clamping function constructed as follows.

A taper bush is attached to a lower surface of a work pallet as a movable member. A cylindrical taper pin which is fitted into a female taper hole of the taper bush is projected upward from a housing of a reference member. An operating rod is inserted into a cylindrical hole of the taper pin, and a taper pressing surface is formed on an upper part of the operating rod. The taper bush is fitted to the taper pin, thereafter, the taper pressing surface of the operating rod presses the work pallet against the housing via a ball and a pressure receiving surface of the taper bush.

Patent Document 1: Japanese Unexamined Patent Publication No. 7-314270

### SUMMARY OF THE INVENTION

### Problem to be Solved by the Present Invention

According to the above-described prior art, it can be expected that the work pallet is accurately and firmly fixed to the reference member, however, the prior art has the following problem.

The taper bush must be attached to the work pallet, so that it is troublesome to manufacture and attach the taper bush and the female taper hole. It is also necessary to accurately machine a taper outer peripheral surface of the taper pin, so that a manufacturing cost thereof is high.

An object of the present invention is to provide a mechanically simple positioning apparatus which can solve the problem.

### Means for Solving the Problem

To achieve the object, a positioning apparatus of the present invention is an apparatus for positioning a movable member with respect to a reference member, for example, as shown in FIG. 1A through FIG. 2B or FIG. 3, and is constructed as follows.

An annular plug 12 to be inserted into an operated hole 11 of a movable member M is projected toward a leading end from a reference member R. In a peripheral wall 13 of the annular plug 12, through holes 14 extending radially are provided at intervals circumferentially. A ball 15 is inserted radially movably in each of the through holes 14. In a cylindrical hole 17 of the annular plug 12, an operating rod 18 is inserted. An outer peripheral surface of a leading end portion of the operating rod 18 is depressed to form accommodating grooves 19 extending axially at intervals circumferentially corresponding to the balls 15. In each of the accommodating grooves 19, a retreating surface 21 which allows the ball 15 to move to a retreating position Y on an radially inward side and a pressing surface 22 which approaches an axis toward a leading end thereof so as to move the ball 15 to a projecting position X on a radially outward side, are provided. Guide surfaces 24, 24, and 24 are formed between the accommodating grooves 19 and 19 adjacent to each other, and these guide surfaces 24 are fitted into the cylindrical hole 17 of the annular plug 12 so as to be prevented from moving radially and allowed to move axially. The operating rod 18 is moved axially by a drive means D.

The positioning apparatus of the present invention brings about the following function and effect.

When positioning a movable member such as a work pallet or a work, first, an operated hole such as a cast hole of the movable member is fitted into an annular plug. Then, an operating rod is advanced toward a leading end by a drive means. Then, a pressing surface of the operating rod changes the balls to the projecting positions and the balls press the operated hole of the movable member radially. Thereby, the movable member moves while aligning and an axis of the operated hole coincides with an axis of the annular plug.

At the time of the above-described positioning, by accurate fitting of the guide surfaces with the cylindrical hole and maintaining the axis of the operating rod concentric with the axis of the annular plug, the movable member can be accurately moved while aligning.

Therefore, according to the present invention, it becomes unnecessary to provide the taper bush and the taper pin of the prior art (Patent Document 1: Japanese Unexamined Patent Publication No. 7-314270) described above, and the positioning apparatus can be mechanically simple. According to the present invention, the operating rod can be sufficiently guided via the guide surfaces, so that an entire guide length of the operating rod can be shortened and a height of the housing can be reduced.

Incidentally, in the prior art, an annular taper gap is present between an upper half of the cylindrical hole of the taper pin and a taper pressing surface of the operating rod, so that the operating rod cannot be guided effectively. In addition, clamp driving is performed after a tapering engagement is made between the taper pin and the taper bush, so that an engagement error between the pressure receiving surface of the taper bush and the balls must be absorbed, and therefore, it is required to provide another annular gap between a lower half of the cylindrical hole and a lower half of the operating rod. Therefore, when the prior art is applied to a positioning apparatus, the operating rod cannot be linearly driven accurately due to the upper and lower annular gaps.

On the other hand, the positioning apparatus of the present invention can hold the axis of the operating rod concentrically with the axis of the annular plug as described above, so that the movable member can be accurately moved while aligning.

In the positioning apparatus of the present invention, when the operating rod 18 is advanced toward the leading end direction, it is preferable that the leading end of the guide surface 24 is positioned closer to the leading end side than a central position of the through hole 14.

In this case, a guide length of the guide surface increases, so that it becomes possible to reliably hold the axis of the operating rod concentrically with the axis of the annular plug and more accurately move the movable member while aligning.

In the positioning apparatus, the operated hole 11 may be a taper hole that has a circular shape in a sectional view and narrows toward an inner part or may be a straight hole having a circular shape in a sectional view. The tapered operated hole may be a cast hole, and the straight operated hole may be a drilled hole or a reamer hole.

A positioning system using the positioning apparatus of the present invention includes at least one positioning apparatus described above.

It is preferable that the positioning system is constructed as follows, for example, as shown in FIG. 4 (and FIG. 1A through FIG. 2B and FIG. 3).

Two positioning apparatuses 51 and 52 are provided at a predetermined interval. In one positioning apparatus 51 of the two positioning apparatuses 51 and 52, three through holes 14 extending radially are formed in a peripheral wall 13 of the annular plug 12 at intervals with angles of substantially 120 degrees circumferentially. In the other positioning apparatus 52 of the two positioning apparatuses 51 and 52, two through holes 14 extending radially are formed in a peripheral wall 13 of the annular plug 12 at an interval with an angle of substantially 180 degrees. Axes of the through holes 14 of the other positioning apparatus 52 are oriented so as to prevent the operated hole 11 corresponding to the annular plug 12 of the other positioning apparatus 52 from rotating with respect to the operated hole 11 corresponding to the annular plug 12 of the one positioning apparatus 51.

By the construction described above, a simple and compact positioning system can be provided.

### BRIEF DESCRIPTION OF THE DRAWINGS

FIG. 1A and FIG. 1B show an embodiment of a positioning apparatus of the present invention, and FIG. 1A is an elevational sectional view of a release state of the positioning apparatus, corresponding to a view indicated by the arrow 1A-1A of FIG. 1B, and FIG. 1B is a sectional view indicated by the arrow 1B-1B of FIG. 1A;

FIG. 2A is a view similar to FIG. 1A, showing a lock state of the positioning apparatus, and FIG. 2B is a view similar to FIG. 1B;

FIG. 3 is a view similar to FIG. 2B, showing an exemplary variation of the positioning apparatus; and

FIG. 4 is a schematic plan view showing an example of a system using the positioning apparatus.

### DESCRIPTION OF THE REFERENCE NUMERALS

11: operated hole, 12: annular plug, 13: peripheral wall of the annular plug 12, 14: through hole, 15: ball, 17: cylindrical hole of the annular plug 12, 18: operating rod, 19: accommodating groove, 21: retreating surface, 22: pressing surface, 24: guide surface, 51: one positioning apparatus, 52: the other positioning apparatus, D: drive means, M: movable member, R: reference member, X: projecting position, Y: retreating position

### BEST MODE FOR CARRYING OUT THE PRESENT INVENTION

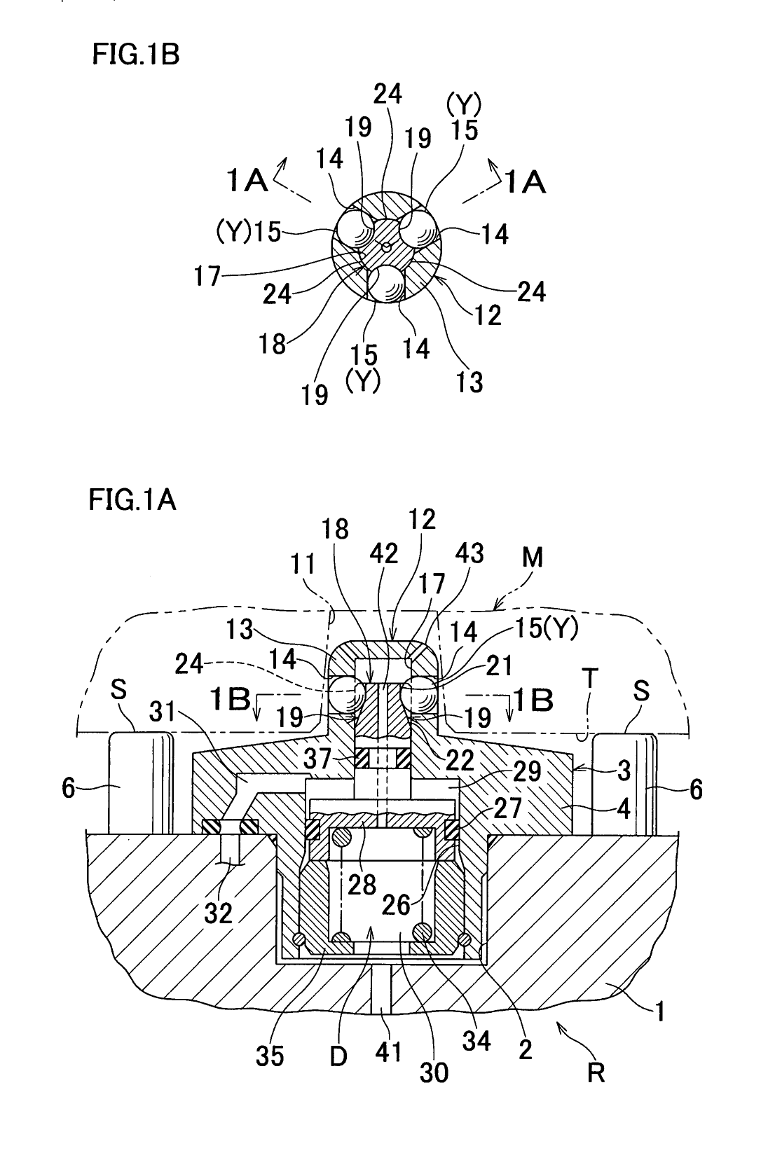

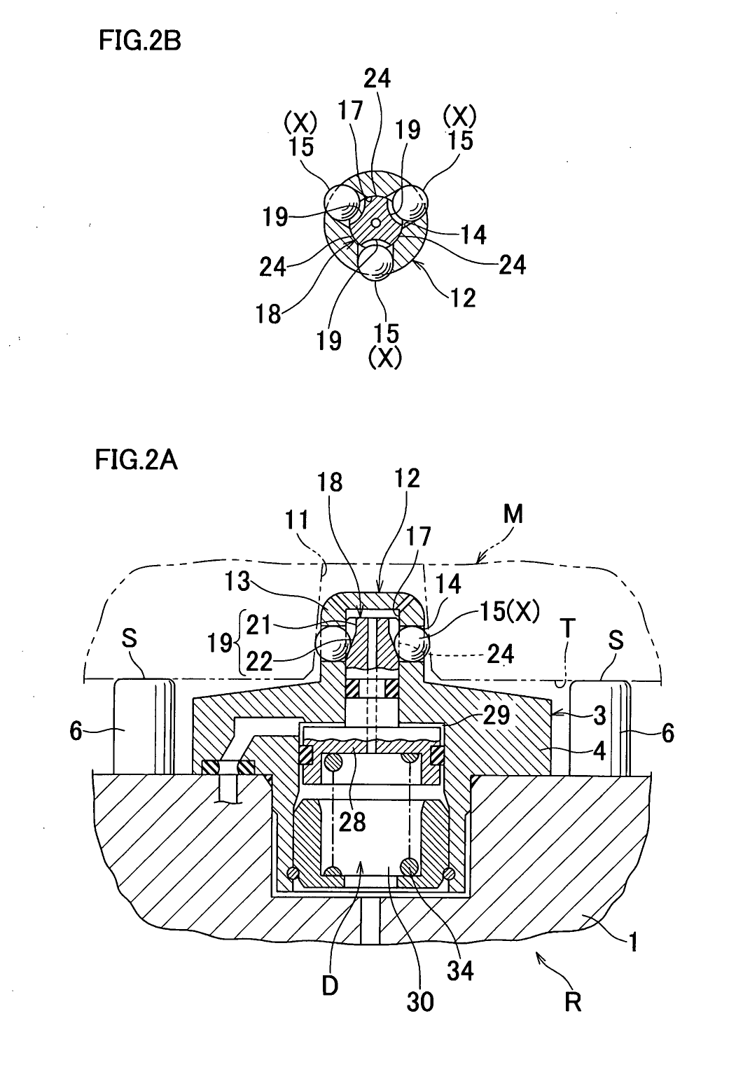

Hereinafter, an embodiment of the present invention will be described with reference to FIG. 1A through FIG. 2B.

FIG. 1A is an elevational sectional view of a release state of a positioning apparatus, corresponding to a view indicated by the arrow 1A-1A of FIG. 1B. FIG. 1B is a view indicated by the arrow 1B-1B of FIG. 1A. FIG. 2A is a view similar to FIG. 1A, showing a lock state of the positioning apparatus. FIG. 2B is a view similar to FIG. 1B.

A reference member R has a work pallet 1, and a lower half of a housing 3 is fitted into an installation hole 2 of the work pallet 1. A flange portion 4 of the housing 3 is fixed to the work pallet 1 by a plurality of bolts (not shown). A plurality of columnar bosses 6 are fixed onto an upper surface of the work pallet 1, and by each support surface S provided on an upper surface of the boss 6, a supported surface T of a work M as a movable member is received.

In the work M, a cast hole 11 as an operated hole is formed. In the cast hole 11, an annular plug 12 projected upward in a dome shape from the housing 3 is inserted.

In a peripheral wall 13 of the annular plug 12, three through holes 14 extending radially are formed at intervals with angles of about 120 degrees circumferentially. In each through hole 14, a ball 15 as an engaging member is inserted radially movably. In a cylindrical hole 17 of the annular plug 12, an operating rod 18 is inserted vertically (axially) movably. An outer peripheral surface at an upper end (leading end) of the operating rod 18 is depressed to form three arched accommodating grooves 19 extending vertically at intervals circumferentially corresponding to the balls 15.

The accommodating groove 19 has a retreating surface 21 and a pressing surface 22 arranged in this order from the upper side. As shown in FIG. 1A and FIG. 1B, by the retreating surface 21, the ball 15 is allowed to move to a retreating position Y radially inward. The pressing surface 22 is inclined so as to approach an axis toward the upper side, and moves the ball 15 to a projecting position X radially outward as shown in FIG. 2A and FIG. 2B. The ball 15 is prevented from protruding by a narrow portion (not shown) formed on an outer end of the through hole 14.

Between the accommodating grooves 19 and 19 adjacent to each other, guide surfaces 24 are formed. The three guide surfaces 24 are accurately fitted into the cylindrical hole 17 so as to be prevented from radially moving and allowed to vertically (axially) move.

The operating rod 18 is reciprocated vertically by a drive means D. The drive means D is constructed as follows.

A cylinder hole 26 is formed in a lower part of the housing 3, and a piston 28 is hermetically inserted into the cylinder hole 26 via a first sealing member 27. An actuation chamber 29 is formed above the piston 28, and a spring chamber 30 is formed below the piston 28. The actuation chamber 29 is communicatively connected to a supply and discharge port 32 for compressed air through a passage 31. A lock spring 34 is installed in the spring chamber 30. An upper end of the lock spring 34 is received by the piston 28, and a lower end of the lock spring 34 is received by a spring seat 35. The piston 28, the actuation chamber 29, and the lock spring 34 form the drive means D.

A lower part of the operating rod 18 is hermetically inserted into the cylindrical hole 17 via a second sealing member 37. The operating rod 18 is integrally formed with the piston 28, however, it may be formed separately from the piston 28.

In a bottom wall of the installation hole 2, a supply port 41 for supplying compressed air for cleaning is opened. The compressed air passes through the supply port 41, the spring chamber 30, a vertical hole 42 formed in the piston 28 and the operating rod 18, an upper space in the cylindrical hole 17, and a plurality of discharge ports 43 formed in a top wall of the plug 12 in the recited order, and is then discharged vigorously to the outside.

The positioning apparatus constructed as described above operates as follows.

In the release state of FIG. 1A and FIG. 1B, compressed air is supplied to the actuation chamber 29, and the piston 28 and the operating rod 18 are lowered against the lock spring 34. Therefore, the retreating surfaces 21 of the operating rod 18 face the balls 15, and the balls 15 are movable to the retreating positions Y. (The drawings illustrate a state in that the balls 15 have already been moved to the retreating positions Y.)

First, as shown in FIG. 1A, the work M is lowered in the release state, and the cast hole 11 in the work M is fitted onto the plug 12 and the supported surface T is received by the support surfaces S.

Next, compressed air in the actuation chamber 29 is discharged. Thereby, as shown in FIG. 2A and FIG. 2B, the lock spring 34 raises the piston 28 and the operating rod 18, and the pressing surfaces 22 of the operating rod 18 change the balls 15 to the projecting positions X, and the balls 15 press the cast hole 11 of the work M radially. Thereby, the work M is moved horizontally while aligning and the axis of the cast hole 11 coincides with the axis of the plug 12.

In the above-described positioning, by accurately fitting the guide surfaces 24 into the cylindrical hole 17 and maintaining the axis of the operating rod 18 concentric with the axis of the plug 12, the work M can be accurately moved while aligning.

When the operating rod 18 is raised, it is preferable that an upper end of the guide surface 24 is positioned higher than a central position of the through hole 14. More preferably, as shown in FIG. 2A, when the operating rod 18 is raised, by positioning the upper end of the guide surface 24 higher than upper end of the through hole 14, a guide length of the guide surface 24 increases and guiding performance is improved.

In the lock state of FIG. 2A and FIG. 2B, a work clamp that is not shown in the drawings presses and fixes the work M onto the support surfaces S.

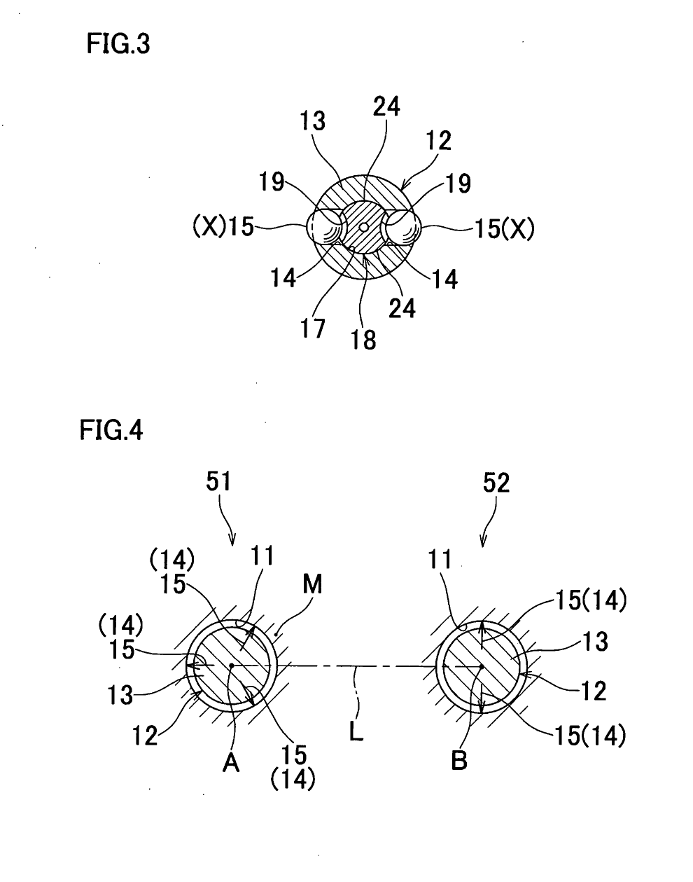

FIG. 3 is a view similar to FIG. 2B, showing an exemplary variation of the positioning apparatus. This exemplary variation will be described by attaching the same reference numerals as in the above-described embodiment to the components identical to those of the above-described embodiment. This exemplary variation has the following difference from the above-described embodiment.

That is, in the peripheral wall 13 of the annular plug 12, two through holes 14 extending radially are provided at an interval with an angle of about 180 degrees.

The above-described embodiment and exemplary variation can be changed as follows.

The operated hole 11 may be a straight hole with a circular shape in a sectional view formed with a drill or reamer instead of the taper hole with a circular shape in a sectional view such as the illustrated cast hole.

Instead of 2 sets or 3 sets of the through hole 14 and ball 15, four sets or more may be provided.

The support surface S may be provided on the housing 3 instead of providing on the illustrated bosses 6.

The drive means D may be a type which performs locking by a pressurized fluid instead of the illustrated spring lock type. The pressurized fluid may be, instead of compressed air, other kinds of gases or liquids such as pressurized oil, etc. The drive means D may be a different type actuator such as a screw engagement type advancing and retreating mechanism or an electromagnet, or a combination structure of a permanent magnet and an electromagnet.

Next, a positioning system using the positioning apparatus will be described based on FIG. 4 with reference to FIG. 1A through FIG. 3. FIG. 4 is a schematic plan view showing an example of the positioning system.

Two positioning apparatuses 51 and 52 are provided at a predetermined interval. In one first positioning apparatus 51, as shown in the above-described embodiment (see FIG. 1A through FIG. 2B), in the peripheral wall 13 of the annular plug 12, three through holes 14 extending radially are formed at intervals with angles of substantially 120 degrees circumferentially. In the other second positioning apparatus 52, as shown in the above-described exemplary variation (see FIG. 3), in the peripheral wall 13 of the annular plug 12, two through holes 14 extending radially are formed at an interval with an angle of substantially 180 degrees. In FIG. 4, directions of pressing the operated holes 11 by the balls 15 inserted into the through holes 14 are indicated by arrows. Namely, the arrows correspond to axes of the through holes 14.

The two positioning apparatuses 51 and 52 are arranged so that, with respect to a straight line L connecting an axis A of the plug 12 of one apparatus and an axis B of the plug 12 of the other apparatus, the through holes 14 of the other apparatus become orthogonal. Thereby, the operated hole 11 of the other apparatus fitted into the plug 12 of the other apparatus is prevented from rotating with respect to the operated hole 11 of the one apparatus fitted into the plug 12 of the one apparatus.

With the above-described construction, absorption of a pitch error between the two operated holes 11 and 11 formed in the work M and reliable positioning of the work M are realized simultaneously.

The through holes 14 of the other apparatus may be orientated so as to become inclined with respect to the straight line L as long as the operated hole 11 of the other apparatus can be prevented from rotating with respect to the operated hole 11 of the one apparatus.

The positioning system described above may be configured in such a manner that both positioning apparatuses 51 and positioning apparatuses 52 are arranged respectively in plural numbers or in such a manner that either one of positioning apparatuses 51 or positioning apparatuses 52 are arranged in plural number.

What is claimed is:

1. A positioning apparatus for positioning a movable member (M) with respect to a reference member (R), comprising:
an annular plug (12) to be inserted into an operated hole (11) of the movable member (M) is projected toward a leading end from the reference member (R),
through holes (14) extending radially are formed at intervals circumferentially in a peripheral wall (13) of the annular plug (12), and a ball (15) is inserted radially movably into each of the through holes (14),
an operating rod (18) is inserted into a cylindrical hole (17) of the annular plug (12),
an outer peripheral surface of a leading end portion of the operating rod (18) is depressed to form accommodating grooves (19) extending axially at intervals circumferentially corresponding to the balls (15), each of the accommodating grooves (19) is provided with a retreating surface (21) which allows the ball (15) to move to a retreating position (Y) radially inward, and a pressing surface (22) which approaches an axis toward the leading end so as to move the ball (15) to a projecting position (X) radially outward,
guide surfaces (24, 24, 24) are formed between the adjacent accommodating grooves (19, 19) and these guide surfaces (24) are fitted into the cylindrical hole (17) of the annular plug (12) so as to be prevented from moving radially and allowed to move axially, and
the operating rod (18) is moved axially by a drive means (D).

2. The positioning apparatus as set forth in claim 1, wherein
when the operating rod (18) is advanced toward the leading end direction, the leading end of the guide surface (24) is positioned closer to the leading end side than a central position of the through hole (14).

3. The positioning apparatus as set forth in claim 1, wherein
the operated hole (11) is a taper hole which has a circular shape in a sectional view and narrows toward an inner part.

4. The positioning apparatus as set forth in claim 3, wherein
the operated hole (11) is a cast hole.

5. The positioning apparatus as set forth in claim 1, wherein
the operated hole (11) is a straight hole which has a circular shape in a sectional view.

6. A positioning system having at least one positioning apparatus as set forth in any one of claims 1 to 5.

7. A positioning system having two positioning apparatuses as set forth in any one of claims 1 to 5 arranged at a predetermined interval, wherein
one positioning apparatus (51) of the two positioning apparatuses (51, 52) is provided with three through holes (14) extending radially at intervals with angles of substantially 120 degrees circumferentially in a peripheral wall (13) of the annular plug (12),
the other positioning apparatus (52) of the two positioning apparatuses (51, 52) is provided with two through holes (14) extending radially at an interval with an angle of substantially 180 degrees in a peripheral wall (13) of the annular plug (12), and
axes of the through holes (14) of the other positioning apparatus (52) are oriented so as to prevent the operated hole (11) corresponding to the annular plug (12) of the other positioning apparatus (52) from rotating with respect to the operated hole (11) corresponding to the annular plug (12) of the one positioning apparatus (51).
